(19) United States
(12) Patent Application Publication
(10) Pub. No.: US 2025/0346420 A1
(43) Pub. Date: Nov. 13, 2025

(54) SHEET MATERIAL WITH DESICCANT PROPERTIES AND USES THEREOF

(71) Applicant: NICOVENTURES TRADING LIMITED, London (GB)

(72) Inventors: Walid Abi AOUN, Southampton (GB); James STEWART, Southampton (GB); Steven HOLFORD, Southampton (GB); Robert PRESS, Southampton (GB)

(21) Appl. No.: 18/864,661

(22) PCT Filed: May 25, 2023
(86) PCT No.: PCT/GB2023/051376

§ 371 Date: Nov. 11, 2024

(30) Foreign Application Priority Data
May 30, 2022 (GB) 2207931.3

(51) Int. Cl. B65D 81/26; B01D 53/26; B01D 53/28; B01J 20/04; B01J 20/28; B65D 85/10; D21H 17/00; D21H 17/02; D21H 17/66; D21H 21/14; D21H 27/00

(52) U.S. Cl. CPC B65D 81/267; B01D 53/261; B01D 53/28; B01J 20/046; B01J 20/2803; B01J 20/28033; B65D 85/1081; D21H 17/02; D21H 17/66; D21H 17/74; D21H 21/14; D21H 27/002; B01D 2253/112; B01D 2257/80; B01D 2258/06

(57) ABSTRACT

The present invention relates to a sheet material having desiccant properties, comprising a base material and a hygroscopic material. The invention also relates to a pack comprising the sheet material, which may be used to hold a consumable for use in a non-combustible aerosol provision system. Methods of preparing the sheet material and uses thereof are also provided.

### FIELD

The present invention relates to a sheet material having desiccant properties. In particular, the invention is proposed for use in packaging an article for use in a non-combustible aerosol provision system, the article comprising an aerosol-generating material. Therefore, the invention also relates to a pack or packaging component comprising the sheet material, as well as methods for manufacturing the sheet material and uses of the sheet material.

### BACKGROUND

Non-combustible aerosol provision systems, including hybrid devices, may contain aerosol-generating material which may comprise tobacco material or a tobacco extract which is used to provide the user with an aerosol with an authentic tobacco taste and texture.

One issue encountered with such systems is that the flavour and the volatile compound and nicotine content decreases with storage of the aerosol-generating material, dropping off particularly towards the end of the life of the material. One reason for this deterioration is that as the aerosol-generating material absorbs moisture from the environment, the release of active substances such as nicotine and flavours is negatively impacted. There is therefore a need to improve the shelf life of the aerosol generating material. The water may come from the environment, for example due to humidity of the air.

### SUMMARY

In a first aspect of the invention, a sheet material having desiccant properties and capable of absorbing moisture from its surrounding environment is provided, wherein the sheet material comprises a base material and a hygroscopic material.

In some embodiments, the sheet material comprises from about 25 to about 70 wt % (DWB) hygroscopic material, based on the total weight of the sheet material.

In some embodiments, the hygroscopic material is selected from the group consisting of: oxides, alkali metal salts, alkaline earth metal salts; mono- and disaccharides; sugar alcohols and polybasic acids and salts thereof.

In some embodiments, the hygroscopic material is selected from the group consisting of: sodium salts, potassium salts, magnesium salts, calcium salts, ammonium salts, and lithium salts.

In some embodiments, the hygroscopic material is selected from the group consisting of: sodium nitrite, sodium nitrate, sodium chloride, sodium bromide, sodium iodide, potassium nitrite, potassium nitrate, potassium chloride, potassium bromide, potassium iodide, potassium sulphate, potassium carbonate, potassium hydroxide, ammonium nitrate, ammonium chloride, ammonium sulphate, ammonium carbonate, calcium chloride, sucrose, fructose, glucose, galactose, sorbitol, xylitol, mannitol, citric acid and salts thereof, malic acid and salts thereof, and succinic acid and salts thereof.

In some embodiments, the base material comprises paper, paperboard or card.

In some embodiments, the hygroscopic material is a powder incorporated into the base material.

In some embodiments, the base material comprises cellulose fibres.

In some embodiments, the sheet material comprises from about 25 to about 50% by weight (DWB) cellulose fibres, based on the total weight of the base material.

In some embodiments, the sheet material further comprises a binder.

In some embodiments, the binder is one or more selected from the group consisting of: alginates, pectins, starches and derivatives thereof, polysaccharides, celluloses and derivatives thereof, gums, silica or silicone compounds, clays, polyvinyl alcohol and combinations thereof.

In some embodiments, the sheet material comprises from about 0.05 to about 30% by weight (dry weight basis) binder, based on the total weight of the sheet material.

In some embodiments, the sheet material has a grammage of from about 20 g/m² to about 250 g/m².

In some embodiments, the sheet material has a thickness of from about 30 μm to about 500 μm.

In some embodiments, the sheet material has a tensile strength of from about 50 N/m to about 900 N/m.

In some embodiments, the sheet material has a wet tensile strength of from about 4 to about 8 N/15 mm.

In some embodiments, the sheet material has a bending resistance of from about 100 to about 350 mN measured using ISO 2493.

In some embodiments, the sheet material has a moisture content of up to about 10%.

In a second aspect of the invention, there is provided a pack comprising the sheet material, wherein the relative humidity within the pack is maintained over time.

In some embodiments, the relative humidity within the pack is maintained within the range of about 9 to about 14%.

In some embodiments, the sheet material is incorporated into the pack as a box, an outer frame, an inner frame, an inner wrapper or an insert.

In some embodiments, the pack defines a chamber for receiving one or more consumables for use in a non-combustible aerosol provision system.

In some embodiments, the pack comprises one or more consumables for use in a non-combustible aerosol provision system.

In a third aspect of the invention, there is provided a method for manufacturing the sheet material, wherein the hygroscopic material is incorporated during or after formation of a sheet from the base material.

In some embodiments, the hygroscopic material is applied on to at least a portion of at least one surface of a sheet of base material.

In some embodiments, the hygroscopic material is added to the base material and the mixture is formed into the sheet material.

In a fourth aspect of the invention, there is provided a use of the sheet material for maintaining the relative humidity within a pack comprising said sheet material.

In some embodiments, the relative humidity is maintained within the range of about 5 to about 30%.

In some embodiments, the use of a sheet material is for maintaining the moisture content of a consumable for use in a non-combustible aerosol provision system below a desired threshold.

In some embodiments, the threshold moisture content of the consumable is up to about 11%.

### BRIEF DESCRIPTION OF THE DRAWINGS

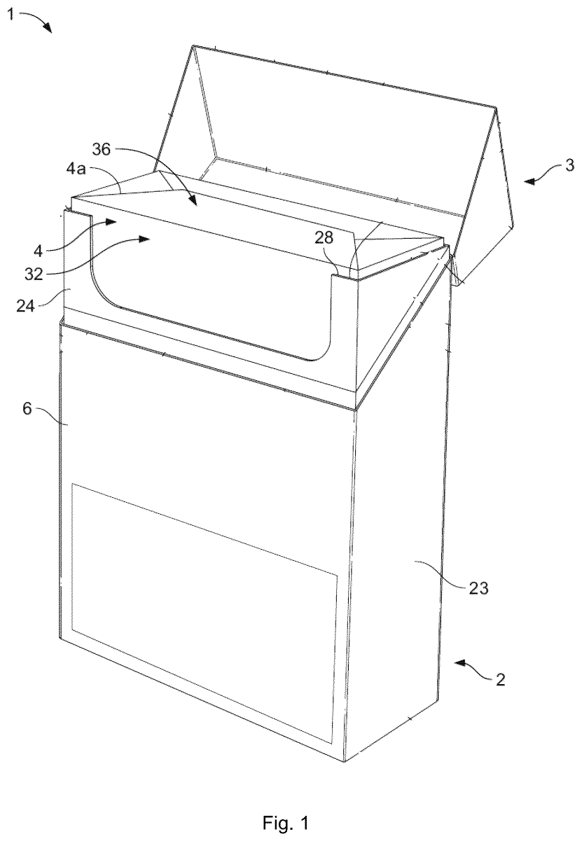

Embodiments of the invention will now be described, by way of example only, with reference to accompanying drawing, in which FIG. 1 shows a perspective view of a package comprising a sheet material having desiccant properties, according to the present invention.

### DETAILED DESCRIPTION

The present invention relates to a sheet material having desiccant properties, comprising a base material and a hygroscopic material.

The sheet material may be incorporated into a pack for an article comprising an aerosol generating material. The desiccant properties of the sheet material mean that the sheet material competes with the aerosol generating material to absorb moisture from the surrounding environment, thus reducing the amount of moisture absorbed by the aerosol-generating material, for example during storage or when the pack is opened and exposed to environmental moisture.

The term desiccant properties refers to the property of inducing or maintaining a state of dryness in the sheet material's vicinity. In the context of the present invention where the sheet material is intended to be incorporated into the packaging for an aerosol-generating article, the vicinity may be defined as the interior of said packaging.

In embodiments in which the sheet material is incorporated into the packaging surrounding an article comprising an aerosol-generating material, the sheet material will be in the vicinity of the aerosol-generating material. The desiccant material in the sheet material will absorb moisture from the environment surrounding the aerosol-generating material, thereby reducing moisture absorption by the aerosol-generating material itself. Thus, the sheet material is able to maintain the moisture content of the aerosol-generating material, preventing or reducing unwanted moisture absorption by the aerosol-generating material whilst it is located in the pack or packaging.

The storage of aerosol-generating material for use in a non-combustible aerosol provision system present presents different challenges to the storage of tobacco material used in conventional combustible smoking articles, such as cigarettes and cigars. The aerosol-generating materials include humectants in larger quantities than are used in tobacco materials of combustible smoking articles. This is because the humectants contribute to the generation or formation of an aerosol when the materials are heated (without combustion). In the case of combustible smoking articles, the tobacco material has a tendency to dry out during storage. As a result, the packaging of such articles frequently includes a moisture impermeable film to keep the moisture inside the packaging. Some smoking article packaging may further include a moisture reservoir which serves to maintain a desired moisture content of the tobacco material. Such moisture reservoirs may comprise a desiccant material which is pre-charged with water so that the desiccant material will maintain the (elevated) moisture levels within the packaging by maintaining a moisture equilibrium.

In contrast, during the storage of aerosol-generating material for use in a non-combustible aerosol provision system, the material has a tendency to absorb moisture from the surrounding environment. It is known that this uptake of water can be associated with a negative impact on the release of active substances such as nicotine and flavours from the aerosol-generating material when it is consumed. Therefore, in the case of an aerosol-generating material for use in a non-combustible aerosol provision system, it is advantageous to protect this material from moisture and to reduce the amount of water that may be absorbed during storage.

In some embodiments, the aerosol-generating material for use in a non-combustible aerosol provision system has a moisture content of from about 10 to about 25% (calculated on a wet weight basis), as measured by gas chromatography-thermal conductivity detector (GC-TCD) or Karl Fischer titration.

The sheet materials of the present invention have desiccant properties so that they will compete with the hygroscopic aerosol-generating material for moisture, thus preventing the aerosol-generating material from absorbing water or reducing the amount of water absorbed.

In some embodiments, the sheet material is intended for use by being located in the vicinity of an aerosol-generating material for use in a non-combustible aerosol provision system. In some embodiments, the sheet material is in the vicinity of the aerosol-generating material whilst in storage. The sheet material may be used to maintain the quality and prolong the shelf-life of the aerosol-generating material by providing a desiccant effect.

### The Sheet Material

The sheet materials provided by the present invention comprise a paper or card base material incorporating a hygroscopic material. The hygroscopic material provides the sheet material with the ability to absorb moisture from the surrounding environment. Indeed, it is important that the hygroscopic material is not wetted before use, so that the sheet material is able to absorb water.

The base material provides the sheet material with its structure and renders the sheet material suitable for use as part of a pack or packaging. As discussed below, in some embodiments this allows the hygroscopic material to be incorporated as an integral or structural part of a pack or packing within which the aerosol-generating material is to be stored.

An advantage associated with the sheet material of the present invention is that it comprises biodegradable, recyclable, or otherwise environmentally-friendly materials which may be sustainably sourced. The sheet material may replace other less sustainable, non-recyclable and/or non-biodegradable materials that are conventionally used in the packaging of consumables comprising aerosol-generating materials to protect these from moisture, such as plastic films and metal foils.

In some embodiments, the sheet material has a grammage of from about 20 g/m² to about 250 g/m². In some embodiments, the sheet material has a grammage of at least about 20 g/m², at least about 30 g/m², at least about 40 g/m², at least about 50 g/m², at least about 60 g/m², at least about 70 g/m², at least about 80 g/m², at least about 90 g/m², at least about 100 g/m², at least about 125 g/m², at least about 150 g/m², at least about 175 g/m², or at least about 200 g/m². In some embodiments, the sheet material has a grammage of up to about 250 g/m², up to about 240 g/m², up to about 230 g/m², up to about 220 g/m², up to about 210 g/m², up to about 200 g/m², up to about 190 g/m², up to about 180 g/m², up to about 170 g/m², up to about 160 g/m², up to about 150 g/m², up to about 125 g/m², up to about 100 g/m², up to about 75 g/m², or up to about 50 g/m². The grammage of the material has an effect on the density of the material, and so can have an effect on the thickness, tensile strength, and bending moment, and may be selected to provide optimised structural integrity of the sheet material. The grammage of the material may be measured in any suitable way known in the art, for example weighing a known area of the material.

In some embodiments, the sheet material has a thickness of from about 30 μm to about 500 μm. The thickness of the sheet material may be measured using a microscope such as a scanning electron microscope (SEM), as known to those skilled in the art, or any other suitable technique known to those skilled in the art. The thickness of the base material can contribute to its structural rigidity and in turn the structural integrity of the sheet material and any item or pack made therefrom.

In some cases, the thickness of the sheet material may vary by no more than about 25%, about 20%, about 15%, about 10%, about 5% or about 1% across its area. This has the advantage that in embodiments in which sheet material is used as part of a pack or packaging. the sheet material has a consistent thickness so that the space for the consumable(s) within the pack or packaging is predictable and can be precise.

The thickness of the sheet can be determined using ISO 534:2011 “Paper and Board-Determination of Thickness”. The inventors have found that thicker sheet materials may perform better in this invention. This may be because thicker material provides an improved tensile strength, and so provides adequate structural integrity to the pack or packaging material. In addition, the thickness of the sheet material may contribute to the appropriate bending resistance of the sheet material. This means that when the material is bent, the shape of the material is retained. Advantageously, this provides a shape to the sheet material and/or support material which fits around the aerosol-generating device and fits the packaging suitably, and may be handled by the user.

In some embodiments, the sheet material has a bending resistance of from about 100 to about 350 mN measured using ISO 2493 in the machine direction (MD), which is the direction of travel during production. In some embodiments, the sheet material has a bending resistance of from about 50 to about 250 mN measured using ISO 2493 in the counter direction (CD), which is the direction at 90° to MD.

In some embodiments, the sheet material has a tensile strength of from about 50 N/m to about 900 N/m. In some embodiments, the sheet material has a tensile strength of from about 50 N/m to about 900 N/m, from about 80 N/m to about 860 N/m, from about 100 N/m to about 820 N/m, from about 140 N/m to about 780 N/m, from about 180 N/m to about 720 N/m.

In some embodiments, the sheet material has a wet tensile strength of from about 4 to about 8 N/15 mm. In some embodiments, the sheet material has a wet tensile strength of from about 5 to about 7, or of about 6 N/15 mm. The wet tensile strength may be measured by any means known in the art, but may be measured using an Instron Tensile & Compression tester.

It is important to select the appropriate thickness, bending strength, tensile strength and/or wet tensile strength of the sheet material so that it is strong enough and malleable enough for its intended purpose. For example, a more rigid sheet material (associated with a higher thickness, bending moment, tensile strength and/or wet tensile strength) may be suitable for a pack, so that the sheet is sturdy and does not crinkle. On the other hand, in embodiments in which the sheet material is used as an inner wrapper within which one or more consumables is wrapped inside a pack, the sheet material must be malleable to fit the shape of the consumable, and strong enough to maintain that shape, and not tear or be otherwise degraded.

In some embodiments, the sheet material has a moisture content of up to about 10%. Such a low moisture content is preferred in order to ensure that the sheet material absorbs water when in use.

In some embodiments, the hygroscopic material is included in the sheet material an amount from about 25 to about 70 wt % (DWB), based on the total weight of the sheet material. In some embodiments, the hygroscopic material is included in the sheet material an amount from about 30 to about 65 wt %, from about 40 to about 60 wt %, from about 50 to about 60 wt %, or from about 52 to about 58 wt % (DWB), based on the total weight of the sheet material.

### The Hygroscopic Material

As used herein, the term hygroscopic refers to the characteristic property of readily taking up and retaining moisture. Thus, a material that is hygroscopic, is a material that readily takes up (by absorption or adsorption) and retains moisture.

In some embodiments of the invention, the hygroscopic material may be selected from the group consisting of: oxides, alkali metal salts, alkaline earth metal salts; mono- and disaccharides; sugar alcohols and polybasic acids and salts thereof. The hygroscopic material is selected from the group consisting of: sodium salts, potassium salts, magnesium salts, calcium salts, ammonium salts, and lithium salts. The hygroscopic material is selected from the group consisting of: magnesium oxide, potassium oxides, copper oxides, aluminium oxides, calcium oxides, sodium hydroxides, phosphorus pentoxides, silicon oxides, and salts thereof. In some embodiments the hygroscopic material is magnesium oxide.

In some embodiments of the invention, the hygroscopic material may be selected from the group consisting of: sodium nitrite, sodium nitrate, sodium chloride, sodium bromide, sodium iodide, potassium nitrite, potassium nitrate, potassium chloride, potassium bromide, potassium iodide, potassium sulphate, potassium carbonate, potassium hydroxide, ammonium nitrate, ammonium chloride, ammonium sulphate, ammonium carbonate, calcium chloride, sucrose, fructose, glucose, galactose, sorbitol, xylitol, mannitol, citric acid and salts thereof, malic acid and salts thereof, and succinic acid and salts thereof.

The hygroscopic material may be stored in reduced humidity conditions, for example less than about 30% humidity, prior to use or incorporation into the sheet material. In some embodiments, manufacturing is an aqueous process followed by drying.

The sheet material may comprise from about 20 to about 80 wt % or about 30-70 wt % of the hygroscopic material (all calculated on a dry weight basis). The sheet material may comprise at least about 20 wt %, about 25 wt %, about 30 wt %, about 35 wt %, about 40 wt %, about 45 wt %, about 50 wt %, about 55 wt %, or at least about 60 wt % of the hygroscopic material (all calculated on a dry weight basis). Additionally or alternatively, the sheet material may comprise up to about 60 wt %, about 65 wt %, about 70 wt %, about 75 wt %, or up to about 80 wt %, of the hygroscopic material (all calculated on a dry weight basis).

In some embodiments, the hygroscopic material may be in the form of a solid material in particulate form, for example, a free-flowing powder. The hygroscopic material in the form of a powder may be incorporated into the base material, or may be applied to the surface of the base material. In some embodiments, the hygroscopic material in the form of a powder may be added to a solvent before it is incorporated into the base material. In such embodiments, the hydroscopic material may be dissolved in the solvent, or may be dispersed in the solvent. The solvent may be an aqueous solvent.

In embodiments in which the hygroscopic material is a powder, each particle of the powder may have a maximum dimension. As used herein, the term “maximum dimension” refers to the longest straight line distance from any point on the surface of a particle of hygroscopic material or on a particle surface, to any other surface point on the same particle of hygroscopic material, or particle surface. The maximum dimension of a particle of particulate tobacco material may be measured using scanning electron microscopy (SEM).

In some embodiments, the maximum dimension of each particle of hygroscopic material in the sheet material is up to about 800 μm. In some embodiments, the maximum dimension of each particle of hygroscopic material is up to about 2000 μm. In some embodiments, the hygroscopic dimension of each particle of tobacco material is about 200 μm to about 800 μm.

A population of particles of the hygroscopic material may have a particle size distribution (D₉₀) of at least about 100 μm. In some embodiments, a population of particles of the hygroscopic material has a particle size distribution (D₉₀) of at least 50 μm, of at least 60, of at least 70 μm, of at least 80 μm, of at least 90, of at least 100 μm, of at least 110 μm, of at least 120 μm, of at least 130 μm. In some embodiments, a population of particles of the hygroscopic material has a particle size distribution (D₉₀) of at most 720 μm, of at most 740 μm, of at most 760 μm, of at most 780 μm, of at most 800 μm, of at most 820 μm, of at most 840 μm, of at most 860 μm. Sieve analysis may be used to determine the particle size distribution of the particles of hygroscopic material.

### Base Material

The sheet material comprises a base material. The base material may provide the sheet material with the desired or required structure and rigidity, for example so that the sheet material may maintain its shape when deformed, as discussed herein.

In some embodiments, the base material comprises paper, paperboard or card. In some embodiments, the base material consists of or consists substantially of paper, paperboard, a paper-based material or a paper-like material.

In some embodiments, the hygroscopic material is applied to paper, paperboard or card base material that is already in the form of a sheet. In such embodiments, the hygroscopic material will tend to be present on one or more surfaces of the sheet of the base material.

In other embodiments, the hygroscopic material is incorporated into the paper or card as a sheet of the base material is manufactured. In these embodiments, the hygroscopic material may be distributed throughout the base material, for example it may be distributed homogeneously throughout the base material. In some embodiments, the hygroscopic material may be concentrated at or near the surface of the base material.

In those embodiments where the hygroscopic material is added to the formed base material, the base material may have a grammage (as assessed according to ISO 536) of from about 20 g/m² to about 90 g/m², from about 25 g/m² to about 35 g/m², or from about 55 g/m² to 65 g/m². In some embodiments, the grammage of the sheet form base material is at least about 15, at least about 20, at least about 25, at least about 30, at least about 35, at least about 40, at least about 45, at least about 50, at least about 60, at least about 70, at least about 80, at least about 90, at least about 100, at least about 110, at least about 120, at least about 130, at least about 140, at least about 150, at least about 160, at least about 180, at least about 190, at least about 200, at least about 210, at least about 220, at least about 230, at least about 240 g/m². In some embodiments, the grammage of the sheet form base material is no more than about 250, no more than about 240, no more than about 230, no more than about 220, no more than about 210, no more than about 200, no more than about 190, no more than about 180, no more than about 170, no more than about 160, no more than about 150, no more than about 140, no more than about 130, no more than about 120, no more than about 110, no more than about 100, no more than about 90, no more than about 80, no more than about 70, no more than about 60, no more than about 55, no more than about 50, no more than about 45, no more than about 40, no more than about 35, no more than about 30 g/m².

In some embodiments, the base material has a thickness of at least about 10 μm. In some cases, the base material has a thickness of at least about 50 μm, at least about 100 μm. In some cases, the base material has a maximum thickness of about 100 μm. In some cases, the base material has a maximum thickness over its area of at most about 500 μm, at most about 300 μm, at most about 200 μm, at most about 100 μm, at most about 95 μm, at most about 90 μm, at most about 85 μm, or at most about 80 μm.

The thickness of the sheet can be determined using ISO 534:2011 “Paper and Board-Determination of Thickness”.

In some embodiments, the base material is a porous paper, such as an air-laid paper. The porous structure of such a paper base material allows the hygroscopic material to be readily added to the base material either during or after manufacture. The pores within this type of base material can accommodate and provide support for the particulate hygroscopic material and the binder used to form the air-laid paper may help to hold the particles of hygroscopic material in place. The pores may also provide space around the particles of hygroscopic material and this may be beneficial as it means that the particles have room to swell as they absorb moisture, which can ensure that the desiccant effect of these particles is not hampered by physical constraints on their expansion.

Incorporation of the Hygroscopic Material into the Sheet Material

In some embodiments, the hygroscopic material is incorporated into the sheet material during the manufacture of the sheet from the base material. In alternative embodiments, the hygroscopic material is added to a sheet of the base material to form the sheet material having desiccant properties. In some embodiments, the hygroscopic material may be added on to at least a portion of at least one surface of the base material.

In some embodiments, the hygroscopic material is added to the components of the base material as a sheet is formed. These embodiments enjoy the advantage that the hygroscopic material is incorporated evenly and throughout the resultant sheet material. This means that the sheet material has desiccant properties throughout the material.

In some embodiments, the sheet material comprises a fibrous material. In some embodiments, the base material comprises a fibrous material. The fibrous material provides structure and rigidity to the base and/or sheet material as described herein. In some embodiments, the fibrous material is selected from wood pulp, cellulose fibres, celluloses, cellulose derivatives or a combination thereof. In some embodiments, the sheet or base material comprises about 25 to about 50% fibrous material of the total mass of the sheet material (on a dry weight basis). In some embodiments, the sheet or base material comprises about 25 to about 50%, about 30 to about 40%, or about 30 to about 35% fibrous material of the total mass of the sheet material (on a dry weight basis).

For example, in some embodiments, the sheet material is formed from a mixture comprising wood pulp or other fibrous material, a binder, and a hygroscopic material. This mixture is then formed into a sheet with the desired physical properties such as thickness, grammage, etc. In some embodiments, the sheet material comprises a fibrous material, a binder and a hydroscopic material.

In some embodiments, the sheet material is formed from the aforementioned mixture comprising the hygroscopic material using conventional methods for forming paper, paperboard or card, i.e. a conventional papermaking process. In other embodiments, the sheet material may be formed using a dry technique so as to form an air-laid material or the like. In other embodiments, the sheet material may be formed using a bandcasting technique.

An advantage of incorporating the hygroscopic material into the sheet of base material is that the resultant sheet material may be more robust, with reduced likelihood that the hygroscopic material may be separated from the base material during the manufacture of a pack using the sheet material or during transport or storage of the sheet material or a pack comprising such material.

In some embodiments, the hygroscopic material is applied to at least one surface of a sheet of the base material. In some embodiments, the hygroscopic material is applied as a coating to the base material. In some embodiments, the hygroscopic material or the coating is sprayed on to the base material. An advantage of providing a coating comprising the hygroscopic material, is that a base material with known properties, such as bending moment and tensile strength, may be used. Further, the location of the hygroscopic material on the surface of the base material means that it will have adequate space to expand as it absorbs moisture. It will also be more exposed to the moisture and therefore will absorb it more readily than a hygroscopic material that is embedded or partially embedded in a base material.

In some embodiments, the sheet material comprises a binder. In embodiments in which the hygroscopic material is applied as a coating to the base material, the coating may comprise a further binder. Suitable binders include, for example, film-forming agents such as polyvinyl alcohol (PVA), gelatin, gums such as acacia gum, guar gum, xanthan gum, carrageenan and agarose, starches and derivatives thereof, polysaccharides, pectins, alginates, wood pulp, celluloses, cellulose derivatives such as carboxymethylcellulose (CMC), hydroxyethyl cellulose and hydroxypropyl cellulose, silica or silicones compounds such as, fumed silica and sodium silicate, clays such as kaolin, pullulan, polydimethylsiloxane (PDMS), and combinations thereof. In some cases, the binder may include alginate and/or pectin, and the precursor material may further comprise a setting agent (such as a calcium source) which may aid formation of the amorphous solid. In some cases, the binder may include a calcium-crosslinked alginate and/or a calcium-crosslinked pectin. In some embodiments the binder is guar gum or CMC.

In some embodiments, the coating comprises at least about 0.05 wt %, at least about 0.08 wt %, at least about 0.1 wt %, at least about 0.5 wt %, at least about 0.8 wt %, at least about 1 wt %, at least about 2 wt %, at least about 3 wt %, at least about 4 wt %, at least about 5 wt %, at least about 10 wt % or at least about 15 wt % of a binder (all calculated on a dry weight basis). In some cases, the coating comprises no more than about 30 wt %, no more than about 25 wt %, no more than about 20 wt %, no more than about 15 wt %, no more than about 10 wt %, no more than about 5 wt %, no more than about 2 wt %, no more than about 1 wt % no more than about 0.5 wt %, no more than about 1 wt % or no more than about 0.08 wt % of a binder (all calculated on a dry weight basis).

In some embodiments, the sheet material comprises at least about 0.05 wt %, at least about 0.08 wt %, at least about 0.1 wt %, at least about 0.5 wt %, at least about 0.8 wt %, at least about 1 wt %, at least about 2 wt %, at least about 3 wt %, at least about 4 wt %, at least about 5 wt %, at least about 10 wt % or at least about 15 wt % of a binder (all calculated on a dry weight basis). In some cases, the sheet material comprises no more than about 30 wt %, no more than about 25 wt %, no more than about 20 wt %, no more than about 15 wt %, no more than about 10 wt %, no more than about 5 wt %, no more than about 2 wt %, no more than about 1 wt % no more than about 0.5 wt %, no more than about 1 wt % or no more than about 0.08 wt % of a binder (all calculated on a dry weight basis).

In some embodiments, the sheet material comprises about 0.06 to about 20 wt %, about 0.08 to about 5 wt %, about 8 to about 12 wt %, about 13 to about 18 wt % of a binder (all calculated on a dry weight basis).

The amount of binder included in the coating and/or the sheet material may be selected to be appropriate for its method of manufacture. For example, in embodiments in which an air laid process is employed, the sheet material may suitably comprise about 10 wt % of guar gum. In another example, in embodiments in which conventional methods for forming paper is employed, the sheet material may suitably comprise about 0.08 wt % guar gum. In a further example, in embodiments in which a bandcast process is employed, the sheet material may suitably comprise about 15 wt % CMC. It is therefore important to select the correct binder and the correct proportion to provide suitable properties of the coating or the sheet material.

In some embodiments, the coating comprises at least about 0.1 wt %, about 1 wt %, about 10 wt %, about 20 wt %, about 30 wt %, about 35 wt %, about 40 wt %, about 45 wt % or at least about 50 wt % of a hygroscopic material (all calculated on a dry weight basis). In some cases, the coating comprises no more than about 99 wt %, about 97 wt %, about 95 wt %, about 90 wt %, about 85 wt %, about 80 wt %, about 75 wt %, about 70 wt %, about 65 wt %, about 60 wt %, about 55 wt %, or about 50 wt % of a hygroscopic material (all calculated on a dry weight basis). In some embodiments, the coating comprises from about 40 to about 70 wt % of a hygroscopic material (all calculated on a dry weight basis).

In some embodiments, the sheet material comprises at least about 0.1 wt %, about 1 wt %, about 10 wt %, about 20 wt %, about 30 wt %, about 35 wt %, about 40 wt %, about 45 wt % or at least about 50 wt % of a hygroscopic material (all calculated on a dry weight basis). In some cases, the sheet material comprises no more than about 99 wt %, about 97 wt %, about 95 wt %, about 90 wt %, about 85 wt %, about 80 wt %, about 75 wt %, about 70 wt %, about 65 wt %, about 60 wt %, about 55 wt %, or about 50 wt % of a hygroscopic material (all calculated on a dry weight basis). In some embodiments, the sheet material comprises about 40-70 wt % of a hygroscopic material (all calculated on a dry weight basis).

The coating may comprise the appropriate amount of binder in order to provide a suitable viscosity. For example, the coating must be viscous enough to form a film and provide a coating having the desired thickness or other physical characteristics. However, if the viscosity of the coating is too great, it may be difficult to apply to the sheet of base material.

Incorporation of Sheet Material into a Pack

In some embodiments of the invention, the sheet material is incorporated into a pack or packaging for storing aerosol-generating material. For example, the aerosol-generating material may be incorporated into an article or consumable which may be stored in the pack or packaging comprising the sheet material. For example, the article may be a Tobacco Heating Product (THP) for use in a non-combustible aerosol provision system.

In some embodiments of the invention, the sheet material is located near or in the vicinity of the aerosol-generating material. For example the sheet material may be located in the packing in the vicinity of a consumable comprising an aerosol-generating material. In some embodiments, the sheet material is used to form the inner bundle in the pack of consumables. This has the advantage that the sheet material has a desiccant effect on the aerosol-generating material, or the environment at least partially around the aerosol-generating material. This means that at least a portion of the aerosol-generating material is maintained in an at least partially dried environment, and reduces moisture available to be absorbed by the aerosol-generating material. This provides an improved environment for storing an aerosol-generating material. The desiccant properties are therefore advantageous when storing the consumable for example, within a device or pack, during transport, pre-sale storage and post-sale storage.

In some embodiments of the invention, the sheet material is incorporated into the pack as a box, an outer frame, an inner frame, an inner wrapper or an insert. This is advantageous, as the sheet material may contribute to a desiccant effect on the contents of the pack, which may, in some embodiments, include one or more articles comprising aerosol-generating material.

In some embodiments, the pack is provided to house one or more consumables for use in a non-combustible aerosol provision system. The pack may comprise one or more of such consumables. In these embodiments, the sheet material incorporated into the pack may provide a desiccant effect to one, some or all of the consumables. This provides an environment with a controlled moisture content for storage of the consumables, and reduces the moisture that the consumables are able to absorb, thus improving their shelf-life and the quality of the aerosol provided when these consumables are used in a non-combustible aerosol provision system.

In some embodiments, the pack comprises from about 5 mg to about 100 mg of hygroscopic material.

The amount of the sheet material in the pack may be selected to provide a suitable desiccant effect. For example, this may be selected based on the size of the pack, or the nature of the consumable(s), or the distance between the sheet material and the aerosol-generating material.

In some embodiments, the sheet material of the invention is incorporated into a pack by forming at least one of the constituent parts of the pack from the sheet material. Thus, the outer frame or the inner frame of a pack may comprise or consist of a sheet material according to the present invention. The sheet material may be the card or paperboard material from which a suitable blank is cut to be folded and assembled into the desired part of the carton or pack.

Additionally or alternatively, the sheet material may be used as an inner wrapper to wrap one or more of the articles to be located within the pack. In such embodiments, the hygroscopic material may be in close proximity to the articles which may be advantageous.

Additionally or alternatively, the sheet material may be used as an insert and is included inside the pack along with one or more of the articles. This insert may be positioned adjacent to the articles within the pack but does not completely surround them (thus is does not act as a wrapper). In such embodiments, the insert may be a paper or paper-like sheet material or a stiffer paperboard or card sheet material.

### Uses of the Sheet Material

In some embodiments of the invention, the relative humidity within a pack comprising said sheet material is maintained within the range of about 5 to about 30%. In some embodiments of the invention, the moisture within a consumable held within a pack comprising said sheet material is maintained within the range of about 5 to about 20%. In some embodiments, the pack is intended to store one or more consumables for use in a non-combustible aerosol provision system.

In some embodiments of the invention, the relative humidity within a pack comprising said sheet material is maintained for at least 365 days. In some embodiments of the invention, the relative humidity within a pack comprising said sheet material is maintained for at least 150, 100, 50, 20 or 10 days. This means that the aerosol-generating material does not absorb significant amounts of moisture over this period. The aerosol-generating material may comprise up to 20% moisture when it is in the vicinity of the sheet material during this period. The moisture content of the aerosol generating material may be higher when the aerosol generating material comprises a humectant, and/or is in the presence of humid conditions. In some embodiments, the aerosol-generating material may comprise about 6 to about 18%, about 8 to about 12%, about 9 to about 14%, or about 10% moisture when it is in the vicinity of the sheet material during this period.

Humidity may be measured in terms of absolute humidity (total mass of water vapour in a given volume of air) or by the dew point (temperature the air must be for water to condense and evaporate at the same rate). Relative humidity is a percentage measurement of water vapour saturation relative to maximum saturation, and indicates the absolute humidity relative to a maximum humidity given the same temperature. Humidity may be measured using a hygrometer or by any other suitable means known in the art.

The inventors have found that it is beneficial to store the sheet material in reduced humidity conditions, for example less than about 30% humidity, prior to use or incorporation into pack for the non-combustible aerosol provision system or articles. This reduces the moisture that the sheet material is exposed to and in turn the amount of moisture the sheet material absorbs.

In some embodiments of the invention, use of the sheet material for maintaining the moisture content of a consumable and/or the aerosol-generating material within the consumable for use in a non-combustible aerosol provision system below a desired threshold is provided. The threshold moisture content of the consumable and/or the aerosol-generating material may be up to about 15%. In some embodiments, the threshold moisture content of the consumable and/or the aerosol-generating material may be up to about 11%. In some embodiments, the moisture content of the consumable and/or the aerosol-generating material may be maintained between about 9 and about 11%.

In some embodiments of the invention, a use of the sheet material for maintaining the moisture content within a pack below a desired threshold is provided. The threshold moisture content within the pack may be up to about 15%. In some embodiments, the threshold moisture content within the pack may be up to about 11%. In some embodiments, the threshold moisture content within the pack may be maintained between about 9 and about 11%.

Maintaining the pack interior or consumable at or below the threshold contributes to maintaining the aerosol-generating material at its moisture content. This provides the benefits as described previously, such as increased shelf life or maintaining the taste and flavour of the aerosol-generating material whilst in storage or in use.

### The Aerosol-Generating Material

An aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

In some embodiments, the aerosol-generating material comprises tobacco material and/or a tobacco extract.

The tobacco extract or material may be from or may be any type of tobacco and any part of the tobacco plant, including tobacco lamina, stem, stalk, ribs, scraps and shorts or mixtures of two or more thereof. Suitable tobacco extracts or materials include the following types: Virginia or flue-cured tobacco, Burley tobacco, Oriental tobacco, or blends of tobacco materials, optionally including those listed here. The tobacco may be expanded, such as dry-ice expanded tobacco (DIET), or processed by any other means. In some embodiments, the tobacco material may be reconstituted tobacco material. The tobacco may be pre-processed or unprocessed, and may be, for instance, solid stems (SS); shredded dried stems (SDS); steam treated stems (STS); or any combination thereof. The tobacco material may be fermented, cured, uncured, toasted, or otherwise pre-treated. The tobacco material may be provided in the form of cut rag tobacco. The cut rag tobacco can have a cut width of at least 15 cuts per inch (about 5.9 cuts per cm, equivalent to a cut width of about 1.7 mm) for example. The cut rag tobacco can be formed from a mixture of forms of tobacco material, for instance a mixture of one or more of paper reconstituted tobacco, leaf tobacco, extruded tobacco and bandcast tobacco.

The aerosol-generating material may comprise one or more active substances and/or flavours, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

At least some of these aerosol former materials are humectants. Glycerol, for example, is a humectant. The inclusion of such humectants can greatly increase the propensity of the aerosol-generating material to absorb moisture.

The one or more other functional materials may comprise one or more of pH regulators, colouring agents, preservatives, binders, fillers, stabilizers, and/or antioxidants.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, Cannabis or another botanical.

In some embodiments, the active substance comprises nicotine. In some embodiments, the active substance comprises caffeine, melatonin or vitamin B12.

As noted herein, the active substance may comprise one or more constituents, derivatives or extracts of Cannabis, such as one or more cannabinoids or terpenes.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, Eucalyptus, star anise, hemp, cocoa, Cannabis, fennel, lemongrass, peppermint, spearmint, rooibos, chamomile, flax, ginger, Ginkgo biloba, hazel, hibiscus, laurel, licorice (liquorice), matcha, mate, orange skin, Papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, Curcuma, turmeric, sandalwood, cilantro, bergamot, orange blossom, myrtle, cassis, valerian, pimento, mace, damien, marjoram, olive, lemon balm, lemon basil, chive, Carvi, Verbena, tarragon, geranium, mulberry, Ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v., Mentha spicata crispa, Mentha cardifolia, Mentha longifolia, Mentha suaveolens variegata, Mentha pulegium, Mentha spicata c.v. and Mentha suaveolens.

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from Eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavour.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, Papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, Cassia, caraway, cognac, jasmine, ylang-ylang, sage, fennel, wasabi, piment, ginger, coriander, coffee, hemp, a mint oil from any species of the genus Mentha, Eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, Curcuma, cilantro, myrtle, cassis, valerian, pimento, mace, damien, marjoram, olive, lemon balm, lemon basil, chive, Carvi, Verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from Cannabis.

In some embodiments, the flavour may comprise a sensate, which is intended to achieve a somatosensorial sensation, which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

### Delivery System and Non-Combustible Aerosol Provision System

As used herein, the term “delivery system” is intended to encompass systems that deliver at least one substance to a user, and includes non-combustible aerosol provision systems that release compounds from an aerosol-generating material without combusting the aerosol-generating material, such as electronic cigarettes, tobacco heating products, and hybrid systems to generate aerosol using a combination of aerosol-generating materials. The term “delivery system” may also encompass systems combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material).

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine.

In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

### EXAMPLES

In a specific example, the sheet material was prepared comprising (on a dry weight basis):

| | | |
|---|---|---|
| Wood pulp | 33.67 | wt % |
| Calcium chloride (10043-52-4) | 54.29 | wt % |
| Guar gum (9000-30-0) | 9.05 | wt % |

This mixture was formed into a sheet using a conventional (wet) paper-making process. In such a process, the wood pulp and the binder, in this case guar gum, are laid on a conveyor to form a sheet which is then dried. In this example, the hygroscopic material, calcium chloride, is added to the mixture before being laid on the conveyor.

In a different example, the sheet material is prepared comprising (on a dry weight basis):

| | |
|---|---|
| Fluff pulp | 50 wt % |
| Silica | 40 wt % |
| Guar gum (9000-30-0) | 10 wt % |

This mixture was formed into a sheet using a conventional (dry) air-laid paper-making process. In this example, the sheet material comprises a coating. The base material comprising wood pulp was laid dry on a mesh to form a sheet. A coating comprising the binder and hygroscopic material was applied by spraying onto a surface of the sheet of base material.

In a yet further example, a paperboard base sheet is provided with a hygroscopic coating by spraying a mixture comprising a particulate hygroscopic material and a binder onto a surface of the sheet of base material. The coating mixture comprises 80% hygroscopic material and 20% binder, or the hygroscopic material and binder in about a 4:1 ratio. The coating may be prepared from a mixture comprising a solvent, for example water, which enables the mixture to be sprayed onto the sheet of base material. The mixture may also comprise glycerol.

In yet a further example, a test was completed in which the water uptake of the sheet material was compared to that of tobacco. The sheet material absorbed 125 wt % of water, compared to 25 wt % of the tobacco. This demonstrated that the sheet material absorbed significantly more water than the tobacco.

Referring to FIG. 1, a pack 1 according to an embodiment of the present invention is shown. The pack 1 comprises an outer frame 23, an inner frame 24 and an inner wrapper 4a that surrounds the articles to be stored in the pack (not shown).

The outer frame 23 comprises a container portion 2 and a lid portion 3. The container 2 forms a receiving space 4 in which a bundle of articles surrounded by a wrapper 4a are receivable. The articles may be consumables for use in a non-combustible aerosol provision system. The lid 3 is attached to the container 2 along a hinge line 5, in order to allow the pack 1 to be opened and closed. It will be appreciated that articles in the receiving space 4 are accessible when the lid 3 is in an open position, and the articles are retained in the receiving space 4 when the lid 3 is in a closed position.

The inner frame 24 is configured to be placed inside the receiving space 4 proximate to or against the inner surface of the container front wall 6. As illustrated, the inner frame 24 partially extends from the open upper end 10 of the outer frame 23 of the container 2. The inner frame 24 is configured to add strength to a portion of the outer frame 23.

Articles, such as consumables for use in a non-combustible aerosol provision system may be inserted and removed by a user through the opening 36 defined by the edges of the inner frame 24, which includes a recess 32.

The inner frame 24 of the container 2 may be a separate part of the package 1 to the outer frame 23 of the container 2. The inner frame 24 may be held in place in the outer frame 23 of the container 2 by, for example, but not limited to, glue. Alternatively, the outer and inner frames 23, 24 may be integrally formed.

One or more of the outer frame, inner frame or inner wrapper may comprise or consist of a sheet material according to the present invention.

For example, in some embodiments, the card or paperboard from which the outer frame and/or inner frame is formed consists of a sheet material according to the present invention. In other embodiments, the card or paperboard from which the outer and/or inner frame is formed comprises a sheet material according to the present invention. For example, the sheet material may be laminated to a further support sheet to form the card or paperboard used. In other embodiments, only a section of part of the outer and/or inner frame is formed from the sheet material according to the present invention.

In some embodiments, the inner wrapper that surrounds the articles to be stored in the pack consists of or comprises a sheet material according to the present invention.

The various embodiments described herein are presented only to assist in understanding and teaching the claimed features. These embodiments are provided as a representative sample of embodiments only, and are not exhaustive and/or exclusive.

It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A sheet material having desiccant properties and capable of absorbing moisture from its surrounding environment, the sheet material comprising a base material and a hygroscopic material.

2. A sheet material as claimed in claim 1, comprising from about 25 to about 70 wt % (DWB) hygroscopic material, based on the total weight of the sheet material.

3. A sheet material as claimed in claim 1 or claim 2, wherein the hygroscopic material is selected from the group consisting of: oxides, alkali metal salts, alkaline earth metal salts; mono- and disaccharides; sugar alcohols and polybasic acids and salts thereof.

4. A sheet material as claimed in claim 3, wherein the hygroscopic material is selected from the group consisting of: sodium salts, potassium salts, magnesium salts, calcium salts, ammonium salts, and lithium salts.

5. A sheet material as claimed in claim 3 or 4, wherein the hygroscopic material is selected from the group consisting of: sodium nitrite, sodium nitrate, sodium chloride, sodium bromide, sodium iodide, potassium nitrite, potassium nitrate, potassium chloride, potassium bromide, potassium iodide, potassium sulphate, potassium carbonate, potassium hydroxide, ammonium nitrate, ammonium chloride, ammonium sulphate, ammonium carbonate, calcium chloride, sucrose, fructose, glucose, galactose, sorbitol, xylitol, mannitol, citric acid and salts thereof, malic acid and salts thereof, and succinic acid and salts thereof.

6. A sheet material as claimed in any one of claims 1 to 5, wherein the base material comprises paper, paperboard or card.

7. A sheet material as claimed in any one of claims 1 to 6, wherein the hygroscopic material is a powder incorporated into the base material.

8. A sheet material as claimed in any one of claims 1 to 7, wherein the base material comprises cellulose fibres.

9. A sheet material as claimed in claim 8, comprising from about 25 to about 50% by weight (DWB) cellulose fibres, based on the total weight of the base material.

10. A sheet material as claimed in any one of claims 1 to 9, wherein the sheet material further comprises a binder.

11. A sheet material as claimed in claim 10, wherein the binder is one or more selected from the group consisting of: alginates, pectins, starches and derivatives thereof, polysaccharides, celluloses and derivatives thereof, gums, silica or silicone compounds, clays, polyvinyl alcohol and combinations thereof.

12. A sheet material as claimed in claim 10 or 11, comprising from about 0.05 to about 30% by weight (dry weight basis) binder, based on the total weight of the sheet material.

13. A sheet material as claimed in any one of claims 1 to 12, having a grammage of from about 20 g/m² to about 250 g/m².

14. A sheet material as claimed in any one of claims 1 to 13, having a thickness of from about 30 μm to about 500 μm.

15. A sheet material as claimed in any one of claims 1 to 14, having a tensile strength of from about 50 N/m to about 900 N/m.

16. A sheet material as claimed in any one of claims 1 to 15, having a wet tensile strength of from about 4 to about 8 N/15 mm.

17. A sheet material as claimed in any one of claims 1 to 16, having a bending resistance of from about 100 to about 350 mN measured using ISO 2493.

18. A sheet material as claimed in any one of claims 1 to 17, having a moisture content of up to about 10%.

19. A pack comprising the sheet material as claimed in any one of claims 1 to 18, wherein the relative humidity within the pack is maintained over time.

20. A pack as claimed in claim 19, wherein the relative humidity within the pack is maintained within the range of about 9 to about 14%.

21. A pack as claimed in claim 19 or claim 20, wherein the sheet material is incorporated into the pack as a box, an outer frame, an inner frame, an inner wrapper or an insert.

22. A pack as claimed in any one of claims 19 to 21, defining a chamber for receiving one or more consumables for use in a non-combustible aerosol provision system.

23. A pack as claimed in any one of claims 19 to 22, comprising one or more consumables for use in a non-combustible aerosol provision system.

24. A method for manufacturing a sheet material as claimed in any one of claims 1 to 18, wherein the hygroscopic material is incorporated during or after formation of a sheet from the base material.

25. A method as claimed in claim 24, wherein the hygroscopic material is applied on to at least a portion of at least one surface of a sheet of base material.

26. A method as claimed in claim 24, wherein the hygroscopic material is added to the base material and the mixture is formed into the sheet material.

27. Use of a sheet material as claimed in any one of claims 1 to 18 for maintaining the relative humidity within a pack comprising said sheet material.

28. Use as claimed in claim 27, wherein the relative humidity is maintained within the range of about 5 to about 30%.

29. Use of a sheet material as claimed in any one of claims 1 to 18 for maintaining the moisture content of a consumable for use in a non-combustible aerosol provision system below a desired threshold.

30. A use as claimed in claim 29, wherein the threshold moisture content of the consumable is up to about 11%.
